(19) United States
(12) Patent Application Publication
(10) Pub. No.: US 2026/0200341 A1
(43) Pub. Date: Jul. 16, 2026

(54) CONTROL SYSTEM FOR VEHICLE

(71) Applicant: TOYOTA JIDOSHA KABUSHIKI KAISHA, Toyota-shi (JP)

(72) Inventors: Kazuma AOKI, Toyota-shi (JP); Takeshi ISHIWADA, Anjo-shi (JP); Hiroto AMADA, Nagakute-shi (JP); Noritaka TAKUDA, Okazaki-shi (JP); Tatsuya KAWAMURA, Nagoya-shi (JP); Takeshi KITAHATA, Toyota-shi (JP)

(73) Assignee: TOYOTA JIDOSHA KABUSHIKI KAISHA, Toyota-shi (JP)

(21) Appl. No.: 19/442,184

(22) Filed: Jan. 7, 2026

(30) Foreign Application Priority Data
Jan. 10, 2025 (JP) 2025-004387

(51) Int. Cl. B60L 15/20

(52) U.S. Cl. CPC B60L 15/2018; B60L 2240/30; B60L 2240/423

(57) ABSTRACT

A control system for a vehicle configured not to generate vibrations and shocks by a torque of a motor counteracting a torsion of a drive shaft locked to park the vehicle. The control system to controls a motor to generate an assist torque counteracting a torsional torque acting on a drive shaft, in a situation where: an inclination angle of the vehicle in the pitching direction at the point when the drive shaft was locked is equal to or greater than the first predetermined angle; torsion of the drive shaft is determined; and an inclination angle of the vehicle in the pitching direction at the point when the drive shaft is released is equal to or greater than the second predetermined angle.

### CROSS-REFERENCE TO RELATED APPLICATIONS

The present disclosure claims the benefit of Japanese Patent Application No. 2025-004387 filed on January 10, 2025 with the Japanese Patent Office, the entire contents of which are hereby incorporated by reference.

### BACKGROUND

### Technical Field

The embodiment of the present disclosure relates to the art of a control system for a vehicle in which a drive shaft is selectively locked by a parking lock mechanism.

### Discussion of the Related Art

JP-A-2015-027134 describes a control apparatus for a vehicle comprising a front drive shaft connected to a front wheel, a rear drive shaft connected to a rear wheel, a front motor connected to the front drive shaft, and a rear motor connected to the rear drive shaft. The vehicle described in JP-A-2015-027134 is provided with a parking lock mechanism that selectively stops the rotation of the front drive shaft. Specifically, the parking lock mechanism stops the rotation of the front drive shaft by engaging a parking pawl with a parking gear interlocked with the front drive shaft, and to allow the front drive shaft to rotate by disengaging the parking pawl from the parking gear.

The control apparatus described in JP-A-2015-027134 is configured to prevent shocks when releasing the front drive shaft by the parking lock mechanism. To this end, according to the teachings of JP-A-2015-027134, the control apparatus obtains: a front phase difference between rotational phases of a front motor before and after stopping the rotation of the front drive shaft by the parking lock mechanism; and a rear phase difference between rotational phases of a rear motor before and after stopping the rotation of the front drive shaft by the parking lock mechanism.

When allowing the front drive shaft to rotate by the parking mechanism, the control apparatus described in JP-A-2015-027134 calculates a torsional stress based on the difference between the front phase difference and the rear phase difference, and generates a torque by the front motor in accordance with the calculated torsional stress.

Thus, control apparatus described in JP-A-2015-027134 is configured to calculate the torsional stress on the front drive shaft based on the rotational phases of the motors at the point when the front drive shaft is locked by the parking lock mechanism, and to determine a magnitude of the torque of the front motor when allowing the front drive shaft to rotate by the parking lock mechanism based on the calculated torsional stress. Nonetheless, there is a time lag between the point at which the torsional stress on the front drive shaft is calculated and the point at which the torque of the front motor is determined based on the torsional stress.

For example, in a case that a vehicle being parked is towed, or in a case that some kind of soft object on which a front wheel of the parked vehicle is stopped is crushed by the front wheel, the torsion of the front drive shaft may be eliminated by the rotation of the front wheel, or the torsional stress may be changed from that at the point when the vehicle was parked. In addition, in a case of towing the parked vehicle, a road grade and a gradient direction will be changed when allowing the front drive shaft to rotate by the parking lock mechanism from those at the point when the front drive shaft was locked by the parking lock mechanism.

Thus, if the parked vehicle is towed, the torsional stress on the front drive shaft may be changed when allowing the front drive shaft to rotate by a change in a road grade or a gradient direction, from the stress calculated when locking the front drive shaft by the parking lock mechanism. In this situation, if the torque of the front motor is determined based on the torsional stress calculated when the vehicle was parked, a magnitude and a direction of the torque generated by the front motor may be different from those of the torque required to reduce the shocks to be generated when the torsion of the front drive shaft is eliminated. Consequently, shocks may be generated when releasing the front drive shaft by the parking lock mechanism.

### SUMMARY

The embodiment of the present disclosure has been conceived noting the foregoing technical problems, and it is therefore an object of the present disclosure to provide a control system for a vehicle configured not to generate vibrations and shocks by a torque of a motor counteracting a torsion of a drive shaft locked to park the vehicle.

A control system according to the exemplary embodiment of the present disclosure is applied to a vehicle, comprising: a drive shaft in which one end thereof is joined to a wheel; a motor that applies a torque to the drive shaft; and a parking lock mechanism that stops a rotation of a predetermined rotary member arranged between the motor and the drive shaft by locking the rotary member, and that allows the rotary member to rotate by releasing the rotary member. In order to achieve the above-explained objective, according to the exemplary embodiment of the present disclosure, the control system is provided with a controller that controls the motor, comprising: a first inclination angle determiner configured to determine whether an inclination angle of the vehicle in the pitching direction at a point when the rotary member is locked by the parking lock mechanism is equal to or greater than a first predetermined angle; a torsion determiner configured to determine whether the drive shaft is twisted after locking the rotary member by the parking lock mechanism; a second inclination angle determiner configured to determine whether the inclination angle of the vehicle in the pitching direction at a point when the rotary member is released by the parking lock mechanism is equal to or greater than a second predetermined angle; and a motor controller configured to control the motor to generate an assist torque in a direction to counteract the torsional torque acting on the drive shaft, in a situation where the inclination angle of the vehicle in the pitching direction at the point when the rotary member was locked by the parking lock mechanism is equal to or greater than the first predetermined angle, torsion of the drive shaft is determined, and the inclination angle of the vehicle in the pitching direction at the point when the rotary member is released by the parking lock mechanism is equal to or greater than the second predetermined angle.

In a non-limiting embodiment, the motor controller may be further configured to determine a magnitude of the assist torque to be generated by the motor in accordance with the inclination angle of the vehicle in the pitching direction at the point when releasing the rotary member by the parking lock mechanism.

In a non-limiting embodiment, the controller may further comprise a motor control inhibitor configured to inhibit the motor to generate the assist torque in a case that a difference between the inclination angle of the vehicle in the pitching direction at the point when the rotary member was locked by the parking lock mechanism and the inclination angle of the vehicle in the pitching direction at the point when the rotary member is released by the parking lock mechanism is equal to or greater than a predetermined value.

In a non-limiting embodiment, the controller may further comprise a motor control inhibitor configured to inhibit the motor to generate the assist torque in a case that the inclination direction of the vehicle in the pitching direction at the point when releasing the rotary member by the parking lock mechanism has changed from that at the point when the rotary member was locked by the parking lock mechanism.

Thus, the control system according to the exemplary embodiment of the present disclosure is configured to control the motor to generate the assist torque counteracting the torsion of the drive shaft in the situation where the inclination angle of the vehicle in the pitching direction at the point when the rotary member connected to the drive shaft was locked by the parking lock mechanism was equal to or greater than the first predetermined angle, the drive shaft is twisted, and the inclination angle of the vehicle at the point when the rotary member is released by the parking lock mechanism is equal to or greater than the second predetermined angle. Therefore, in the case that the posture of the vehicle being parked is changed when e.g., the vehicle is towed, the motor is prevented from generating the assist torque. In other words, in the case that the vehicle being parked is towed and then laid in a horizontal attitude so that the torsion of the drive shaft is eliminated, the motor is prevented from generating the assist torque. For this reason, the vehicle will not be vibrated by the assist torque of the motor when releasing the drive shaft by the parking lock mechanism.

As described, the control system according to the exemplary embodiment of the present disclosure is further configured to determine a magnitude of the assist torque to be generated by the motor in accordance with the inclination angle of the vehicle in the pitching direction at the point when releasing the rotary member by the parking lock mechanism. Therefore, a target value of the assist torque will not be changed even if a detected value of the inclination angle of the vehicle is fluctuated, or even if a signal representing the inclination angle of the vehicle contains a noise. For this reason, the assist torque of the motor will not be changed by the factors other than the torsion of the drive shaft so that the vehicle Ve may be prevented from being vibrated.

As also described, the control system according to the exemplary embodiment of the present disclosure is further configured to inhibit the motor to generate the assist torque in the case that the difference between the inclination angle of the vehicle in the pitching direction at the point when the rotary member was locked by the parking lock mechanism and the inclination angle of the vehicle in the pitching direction at the point when the rotary member is released by the parking lock mechanism is equal to or greater than the predetermined value. That is, the control system inhibits the generation of the assist torque when the posture of the vehicle is changed, in other words, when a torsion angle of the drive shaft is changed. Therefore, the vehicle will not be vibrated by the assist torque of the motor even when the posture of the vehicle or the torsion angle of the drive shaft is changed.

As also described, the control system according to the exemplary embodiment of the present disclosure is further configured to inhibit the motor to generate the assist torque in the case that the inclination direction of the vehicle in the pitching direction at the point when releasing the rotary member by the parking lock mechanism has changed from that at the point when the rotary member was locked by the parking lock mechanism. That is, the generation of the assist torque by the motor is inhibited when the torsional direction of the drive shaft is reversed. Therefore, the vehicle will not be vibrated by the assist torque of the motor even when the inclination direction of the vehicle is changed.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing one example of a structure of the vehicle to which the control system according to the exemplary embodiment of the present disclosure is applied;

FIG. 2 is a block diagram showing functions of the controller;

FIG. 3 is a flowchart showing one example off a routine for setting a torsion flag;

FIG. 4 is a flowchart showing one example off a routine for setting a motor control execution flag;

FIG. 5 is a flow chart showing one example of a routine for determining an assist torque;

FIG. 6 shows one example of a map for determining a target torque in accordance with an inclination angle of the vehicle;

FIG. 7 is a flow chart showing one example of a routine for setting the motor control execution flag based on an inclination angle of the vehicle at a point when the front drive shaft was twisted and a current inclination angle of the vehicle; and

FIG. 8 is a flow chart showing one example of a routine for setting the motor control execution flag based on an inclination direction of the vehicle at a point when the front drive shaft is twisted and a current inclination direction of the vehicle.

### DETAILED DESCRIPTION OF THE EMBODIMENT(S)

An embodiment of the present disclosure will now be explained with reference to the accompanying drawings. Note that the embodiments shown below are merely examples of the present disclosure, and do not limit the present disclosure.

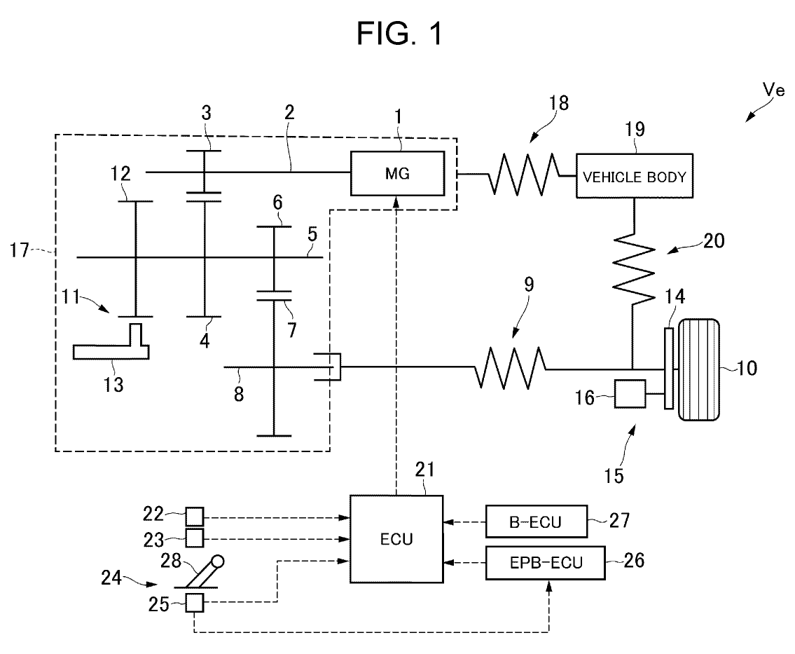

Referring now to FIG. 1, there is shown one example of a structure of a vehicle Ve to which the control system according to the exemplary embodiment of the present disclosure is applied. The vehicle Ve shown in FIG. 1 is an electric vehicle comprising a motor (referred to as MG in FIG. 1) 1 as a prime mover. As the motor 1, a motor serving as a prime mover of conventional electric vehicles and hybrid vehicles may be employed. The motor 1 is operated as a motor to generate a driving torque by supplying electric power thereto from a power storage device (not shown), and as a generator to translate a kinetic power of an output shaft 2 thereof into electric power at least partially by rotating the output shaft 2 passively. For example, a permanent magnet synchronous motor or an induction motor may be adopted as the motor 1.

A first drive gear 3 is mounted on the output shaft 2 of the motor 1, and a first driven gear 4 is mounted on an intermediate portion of the intermediate shaft 5 extending parallel to the output shaft 2 of the motor 1 to be meshed with the first drive gear 3. The first driven gear 4 is diametrically larger than the first drive gear 3 so that the first drive gear 3 and the first driven gear 4 serve as a reduction gear pair.

A second drive gear 6 is mounted on one end of the intermediate shaft 5, and a second driven gear 7 is mounted on an output shaft 8 extending parallel to the output shaft 2 and the intermediate shaft 5 to be meshed with the second drive gear 6. The second driven gear 7 is diametrically larger than the second drive gear 6 so that the second drive gear 6 and the second driven gear 7 also serve as a reduction gear pair. One end of the drive shaft 9 is joined to the output shaft 8 to rotate integrally therewith, and a wheel 10 is joined to the other end of the drive shaft 9.

The vehicle Ve is provided with a parking lock mechanism 11 that stops the rotation of the intermediate shaft 5 by locking the intermediate shaft 5, and allows the intermediate shaft 5 to rotate by releasing the intermediate shaft 5. A structure of the parking lock mechanism 11 is similar to those of parking lock mechanisms employed in the conventional vehicles. Specifically, the parking lock mechanism 11 comprises a parking lock gear 12 mounted on the other end of the intermediate shaft 5, a parking pawl 13 selectively engaged with the parking lock gear 12, and an actuator (not shown) for rotating the parking pawl 13. When a shift lever 28 of an after-mentioned shifting device 24 is moved to a parking position, the parking pawl 13 is rotated by the actuator to be meshed with the parking lock gear 12 thereby stopping a rotation of the parking lock gear 12. As a result, the rotation of the drive shaft 9 connected to the parking lock gear 12 through the intermediate shaft 5 in a torque transmittable manner is stopped.

A braking torque is applied to the wheel 10 by a brake device 14 according to a depression of a brake pedal (not shown) operated by a driver. As the brake device 14, brake devices arranged in the conventional vehicles may be employed. For example, a disk brake that applies a braking torque to the wheel 10 by clamping a brake rotor rotating integrally with the wheel 10 by a brake pad, and a drum brake that applies a braking torque to the wheel 10 by pressing a brake shoe from inside of a drum rotating integrally with the wheel 10 may be adopted as the brake device 14. A clamping force of the brake pad and a pushing force of the brake shoe may be controlled by an actuator (not shown) that generates a hydraulic pressure or an electromagnetic force in accordance with a depression of the brake pedal.

The vehicle Ve further comprises an electric parking brake (hereinafter, referred to as EPB) 15. When the shift lever 28 of the shifting device 24 is moved to the parking position, a motor 16 is activated to actuate a caliper or a brake shoe (neither of which are shown) of the EPB 15 to apply a braking torque to the wheel 10. Whereas, when the shift lever 28 of the shifting device 24 is moved to a position other than the parking position, the EPB 15 reduces the braking torque applied to the wheel 10. In order to fit the motor 16 easily into the vehicle Ve, the motor 16 may be arranged in a vehicle body, and the motor 16 and the caliper or the brake shoe may be connected to each other through a wire. In this case, the caliper and the brake shoe are actuated by rotating the motor 16 to wind up the wire.

In the vehicle Ve, the motor 1 and a gear train for delivering a torque from the motor 1 to the output shaft 8 are held in a case 17, and the case 17 is connected to a vehicle body 19 through a mount 18. The wheel 10 is connected to the vehicle body 19 through a suspension 20.

An operating mode of the vehicle Ve is allowed to be shifted to a parking mode by moving the shift lever 28 to the parking position while depressing the brake pedal. In the parking mode, a rotation of the intermediate shaft 5 is stopped by the parking lock mechanism 11, and a braking torque is applied to the wheel 10 by the EPB15.

When the above-mentioned shifting operation is executed by the driver to shift the operating mode to the parking mode, the rotation of the intermediate shaft 5 is stopped by the parking lock mechanism 11 before the braking torque is applied to the wheel 10 by the EPB15. In this situation, given that the vehicle Ve is parked on a slope or that the vehicle Ve is parked such that some of the wheels 10 is/are stopped on a curb, the vehicle Ve is inclined in the pitching direction. In this case, if the driver returns the brake pedal before the braking torque is applied to the wheel 10 by the EPB 15, the wheel 10 will rotate even though the rotation of an input section of the drive shaft 9 is stopped. In addition, if the EPB 15 cannot function properly for some reason, the wheel 10 will also rotate after returning the brake pedal even though the rotation of the input section of the drive shaft 9 is stopped. As a result, the drive shaft 9 is twisted. That is, the drive shaft 9 is subjected to a torque (i.e., a torsional torque) in accordance with an elastic modulus and a torsion angle thereof.

If the operating mode is shifted to a mode other than the parking mode in the situation where the drive shaft 9 is twisted, the torsion of the drive shaft 9 is eliminated when the intermediate shaft 5 locked by the parking lock mechanism 11 is released, and the torsional torque acting on the drive shaft 9 propagates toward the motor 1. As a result, the torque transmitted to the motor 1 is pulsated in accordance with the elastic modulus of the drive shaft 9 thereby vibrating the vehicle Ve.

In addition, the suspension 20 is vibrated vertically by the pulsation of the torque of the drive shaft 9 thereby vibrating the vehicle Ve.

In the situation where the drive shaft 9 is twisted, such vibrations of the vehicle Ve may be suppressed by generating an assist torque by the motor 1 to counteract the torsional torque acting on the drive shaft 9, when the intermediate shaft 5 is released by the parking lock mechanism 11.

For example, in a case that the vehicle Ve being parked is towed, a frictional force acting between the wheel 10 and a road surface may be changed thereby changing a torsion angle of the drive shaft 9. Likewise, in a case that the vehicle Ve is towed in a situation where the braking torque cannot be applied to the wheel 10 by the EPB 15 for some reason, the wheel 10 is rotated thereby changing a torsion angle of the drive shaft 9. Further, in a case that the torque applied to the wheel 10 from the road surface when towing the vehicle Ve is greater than the braking torque established by the EPB 15, the wheel 10 is rotated thereby changing a torsion angle of the drive shaft 9.

In addition, in a case that an inclination angle of the vehicle Ve changes in a situation where the braking torque of the EPB 15 cannot be applied to the wheel 10 for some reason, the wheel 10 is rotated thereby changing a torsion angle of the drive shaft 9.

Thus, in the above-explained situations, the torsion angle of the drive shaft 9 may be changed when the drive shaft 9 is released by the parking lock mechanism 11 from the torsion angle at the point when the drive shaft 9 was locked by the parking lock mechanism 11. In this case, if the assist torque to be generated by the motor 1 is controlled based on the torsion angle at the point when the drive shaft 9 was locked, the assist torque may be excessive or insufficient to reduce the shocks or vibrations to be generated when releasing the drive shaft 9 by the parking lock mechanism 11, and as a result, the vehicle Ve may be vibrated.

Therefore, the control system according to the exemplary embodiment of the present disclosure is configured to control the motor 1 to generate the assist torque in a situation where an inclination angle of the vehicle Ve in the pitching direction is equal to or greater than a predetermined angle when releasing the drive shaft 9 being twisted by the parking lock mechanism 11. To this end, the control system is provided with an electronic control unit (hereinafter abbreviated as the ECU) 21 serving as a controller for controlling the motor 1. The ECU21 comprises a microcomputer configured to control an output torque of the motor 1 on the basis of incident signals using calculation expressions stored in advance.

The ECU 21 is connected with an acceleration sensor 22 that detects a longitudinal acceleration of the vehicle Ve, a resolver 23 that detects a rotational speed (or a rotational angle) of the motor 1, and a shift sensor 25 that detects the operating mode selected by the shifting device 24, so that signals are transmitted to the ECU 21 from the sensors 22, 23, and 25. In addition, an EPB-ECU 26 for controlling the EPB 15 and a B-ECU 27 for controlling the brake device 14 are also connected with the ECU 21 so that signals are also transmitted to the ECU 21 from the EPB-ECU 26 and the B-ECU 27.

For example, a so-called momentary shifting device may be adopted as the shifting device 24. In this case, when the shift lever 28 is moved from the initial position to a desired position, a signal corresponding to the position of the shift lever 28 is transmitted to the ECU 21 from the shift sensor 25, and when the shift lever 28 is released, the shift lever 28 returns to the initial position. As an option, the shifting device 24 may be provided with a parking button for selecting a parking mode, and the shift sensor 25 may be activated by pressing the parking button.

The EPB-ECU 26 is connected with the shift sensor 25. Specifically, the EPB-ECU 26 is configured to determine whether the EPB 15 is activated based on a signal transmitted from the shift sensor 25, and to transmit a command signal to the ECU 21 or the motor 16 based on a determination result. For example, a signal representing a depression of the brake pedal, a signal representing a pedal force applied to the brake pedal, and a signal representing a pressure of a master cylinder are transmitted to the B-ECU27. Otherwise, a detection signal of a hydraulic pressure or an electromagnetic force for generating a braking torque by the brake device 14 is transmitted to the B-ECU27. Specifically, the B-ECU27 is configured to calculate a braking torque to be generated by the brake device 14 based on the incident signals, and to transmit a command signal to the ECU 21 based on the calculated braking torque.

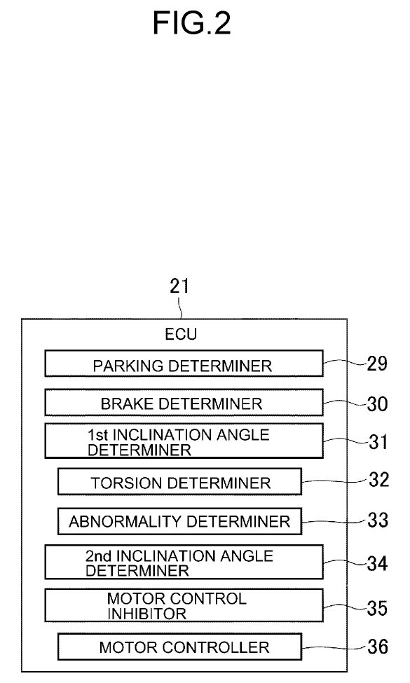

Turning to FIG. 2, there are shown functions of the ECU 21. As shown in FIG. 2, the ECU 21 comprises a parking determiner 29, a brake determiner 30, a first inclination angle determiner 31, a torsion determiner 32, an abnormality determiner 33, a second inclination angle determiner 34, a motor control inhibitor 35, and a motor controller 36.

The parking determiner 29 is configured to determine whether the vehicle Ve is in the parking mode in which the rotation of the intermediate shaft 5 is stopped by the parking lock mechanism 11. In other words, the parking determiner 29 is configured to determine whether the intermediate shaft 5 is locked by the parking lock mechanism 11. Specifically, the parking determiner 29 determines that the vehicle Ve is in the parking mode based on a fact that a predetermined time has elapsed since the shift lever 28 was moved to the parking position, or a fact that a command signal for actuating the parking pawl 13 is transmitted to the actuator.

The brake determiner 30 is configured to determine whether a braking torque applied to the wheel 10 is equal to or less than a predetermined torque. Specifically, the brake determiner 30 determines whether the braking torque applied to the wheel 10 is equal to or less than a predetermined torque based on the signals transmitted from the EPB-ECU 26 and the B-ECU 27 to the ECU 21. To this end, the predetermined torque may be set to a magnitude by which the wheel 10 will not rotate given that the vehicle Ve is stopped on a road at a predetermined gradient determined based on the specifications of the vehicle Ve.

The first inclination angle determiner 31 is configured to determine whether an absolute value of the inclination angle of the vehicle Ve in the pitching direction at the point when the intermediate shaft 5 was locked by the parking lock mechanism 11 is equal to or greater than a first predetermined angle. Specifically, the first inclination angle determiner 31 measures the inclination angle of the vehicle Ve based on a longitudinal acceleration of the vehicle Ve detected by the acceleration sensor 22, and determines whether or not the measured inclination angle of the vehicle Ve is equal to or greater than an angle by which the wheel 10 is rotated given that the braking torque is not applied to the wheel 10.

The torsion determiner 32 is configured to determine torsion of the drive shaft 9. For example, the torsion determiner 32 determines that the drive shaft 9 is twisted if the intermediate shaft 5 (or the drive shaft 9) is locked by the parking lock mechanism 11 and the braking torque applied to the wheel 10 is equal to or less than the predetermined torque in the situation where the inclination angle of the vehicle Ve is equal to or greater than the predetermined angle. That is, the torsion determiner 32 determines that the drive shaft 9 is twisted within a predetermined period of time after the drive shaft 9 was locked by the parking lock mechanism 11.

The abnormality determiner 33 is configured to determine an occurrence of abnormality in a case that the braking torque applied to the wheel 10 by the brake device 14 or the EPB 15 is out of control, or that the ECU 21 cannot receive the signal representing braking torque. Specifically, the abnormality determiner 33 determines whether or not a signal representing a malfunction of the brake device 14 or the EPB 15 is transmitted from the EPB-ECU 26 or the B-ECU 27 to the ECU 21, and whether or not a communication error occurs between the EPB-ECU 26 or the B-ECU 27 and the ECU 21. In other words, the abnormality determiner 33 determines whether or not a precondition for generating the assist torque by the motor 1 is satisfied, and transmits a determination result to the torsion determiner 32.

The second inclination angle determiner 34 is configured to determine whether the inclination angle of the vehicle Ve in the pitching direction at the point when the intermediate shaft 5 is released by the parking lock mechanism 11 is equal to or greater than a second predetermined angle. The second predetermined angle may be set to the same angle as the aforementioned first predetermined angle which is greater than the angle by which the wheel 10 is rotated given that the braking torque is not applied to the wheel 10.

The motor control inhibitor 35 is configured to inhibit the motor 1 to generate the assist torque when the difference between: the inclination angle of the vehicle Ve in the pitching direction at the point when the intermediate shaft 5 (or the drive shaft 9) was locked by the parking lock mechanism 11; and the inclination angle of the vehicle Ve in the pitching direction at the point when the intermediate shaft 5 (or the drive shaft 9) is released by the parking lock mechanism 11, is equal to or greater than a predetermined value. This is because the vehicle Ve will be vibrated if the motor 1 generates the assist torque in the situation where the posture of the vehicle Ve changes from that at the point when the torsion of the drive shaft 9 was determined.

When the inclination direction of the vehicle Ve in the pitching direction changes, a torsional direction of the drive shaft 9 is reversed. In this situation, if the motor 1 generates the assist torque in accordance with the inclination direction of the vehicle Ve in the pitching direction at the point when the intermediate shaft 5 (or the drive shaft 9) was locked by the parking lock mechanism 11, the vehicle Ve may be vibrated. Therefore, the motor control inhibitor 35 inhibits the generation of the assist torque by the motor 1 in the case that the inclination direction of the vehicle Ve in the pitching direction has changed when releasing the intermediate shaft 5 (or the drive shaft 9) by the parking lock mechanism 11 from that at the point when the intermediate shaft 5 (or the drive shaft 9) was locked by the parking lock mechanism 11.

The motor controller 36 is configured to control the motor 1 to generate the assist torque counteracting the torsional torque acting on the drive shaft 9 when allowing the intermediate shaft 5 to rotate by the parking lock mechanism 11, in the case that the torsion of the drive shaft 9 is determined by the torsion determiner 32. Specifically, the motor controller 36 determines a magnitude of the assist torque to be generated by the motor 1 in accordance with the inclination angle of Ve at the point when releasing the intermediate shaft 5 by the parking lock mechanism 11.

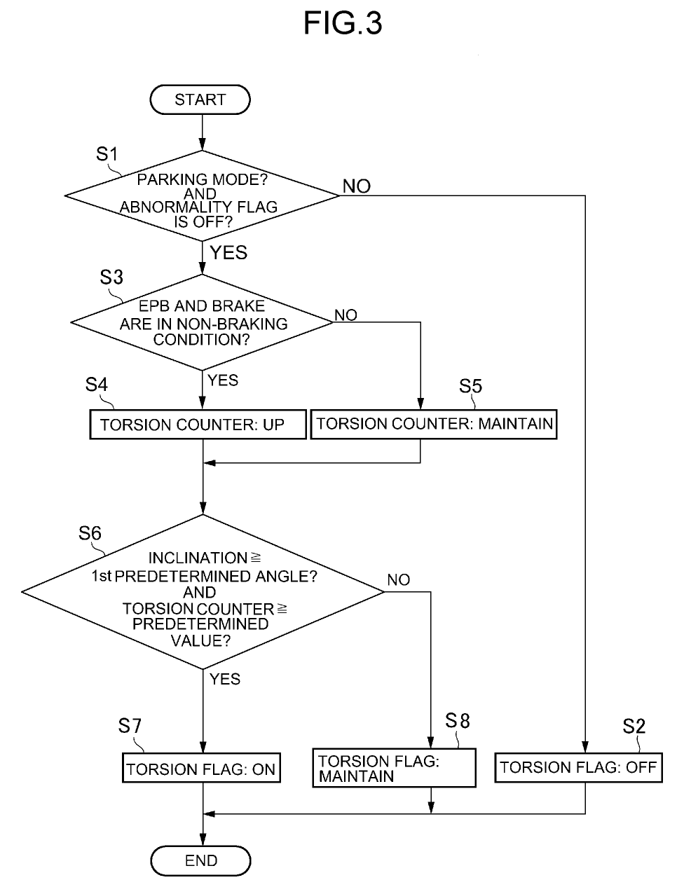

Thus, the control system according to the exemplary embodiment of the present disclosure determines the torsion of the drive shaft 9 when locking the intermediate shaft 5 by the parking lock mechanism 11, and thereafter generates the assist torque by the motor 1 when releasing the intermediate shaft 5 by the parking lock mechanism 11. To this end, first of all, the control system according to the exemplary embodiment of the present disclosure execute the routine shown in FIG. 3 to determine whether the drive shaft 9 is twisted when locking the intermediate shaft 5 by the parking lock mechanism 11. At step S1, the parking determiner 29 determines whether the parking mode is selected, and the abnormality determiner 33 determines whether the abnormality flag is on. Specifically, such determination at step S1 may be made based on the fact that a predetermined period of time has elapsed since the shift lever 28 was moved to the parking position, or the command signal for actuating the parking pawl 13 is transmitted to the actuator.

Specifically, the abnormality flag is turned on in a situation where the braking torque applied to the wheel 10 by the brake device 14 or the EPB 15 is out of control, or in a situation where the ECU 21 cannot receive the signal representing braking torque. That is, the abnormality determiner 33 determines whether the brake device 14 and the EPB 15 function properly, and whether the ECU 21 functions properly to receive the signals representing operations of those brakes.

If the parking mode is not selected or if the abnormality flag is on so that the answer of the step S1 is NO, the routine progresses to step S2 to turn off a torsion flag representing torsion of the drive shaft 9. That is, the torsion determiner 32 determines that the drive shaft 9 is not twisted, and thereafter the routine returns. When the torsion flag is turned off, a count value of an after-mentioned torsion counter is reset to zero.

By contrast, if the parking mode is selected and the abnormality flag is off so that the answer of step S1 is YES, the routine progresses to step S3 to determine whether each of the EPB 15 and the brake device 14 is in a non-braking condition. That is, it is determined at step S3 whether or not the condition to twist the drive shaft 9 is satisfied. At step S3, specifically, the brake determiner 30 determines whether or not the wheel 10 is still allowed to rotate even through a rotation of the input section of the drive shaft 9 has been stopped. In other words, it is determined at stepS3 whether the braking torque has not yet applied sufficiently to the wheel 10. The braking torque applied to the wheel 10 by the EPB 15 begins to increase after the lapse of a predetermined time from the commencement of power supply to the motor 16. However, the vehicle Ve is not provided with a sensor for detecting the timing at which the braking torque starts acting on the wheel 10. Therefore, a fact that the braking torque generated by the EPB 15 has not yet been applied to the wheel 10, that is, the fact that the EPB 15 is in the non-braking condition may be determined if an elapsed time from the commencement of the power supply to the motor 16 is still shorter than a predetermined period of time.

If each of the EPB 15 and the brake device 14 is in the non-braking condition so that the answer of step S3 is YES, a torsion angle of the drive shaft 9 may be increased. Therefore, if the answer of step S3 is YES, the routine progresses to step S4 to increment a count value of the torsion counter. By contrast, if at least any one of the EPB 15 and the brake device 14 is applying the braking torque to the wheel 10 so that the answer of step S33 is NO, the routine progresses to step S5 to maintain the count value of the torsion counter.

Then, at step S6, the first inclination angle determiner 31 determines whether an absolute value of an inclination angle of the vehicle Ve in the pitching direction is equal to or greater than the first predetermined angle, and the torsion determiner 32 determines whether the counter value of the torsion counter is equal to or greater than the predetermined value. Specifically, the first inclination angle determiner 31 measures the inclination angle of the vehicle Ve based on a longitudinal acceleration of the vehicle Ve detected by the acceleration sensor 22, and determines whether or not the measured inclination angle of the vehicle Ve is equal to or greater than the first predetermined angle by which the wheel 10 is rotated.

On the other hand, the predetermined value employed at step S6 is a length of an elapsed time from a point at which the braking torque applied to the wheel 10 was cancelled to a point at which the torsion angle of the drive shaft 9 is increased to an angle at which the assist torque has to be generated by the motor 1 to suppress the shock caused by releasing the intermediate shaft 5 by the parking lock mechanism 11. For example, the predetermined value is determined based on a result of an experiment or a simulation conducted in advance. Since a rate of temporal change in the torsion angle of the drive shaft 9 differs depending on an inclination angle of the vehicle Ve, the predetermined value may be a variable which is reduced with an increase in the inclination angle of the vehicle Ve.

If the inclination angle of the vehicle Ve is equal to or greater than the first predetermined angle and the count value of the torsion counter is equal to or greater than the predetermined value so that the answer of step S6 is YES, the routine progresses to step S7 to turn on the torsion flag, and thereafter returns. By contrast, if the inclination angle of the vehicle Ve is less than the predetermined angle, or if the count value of the torsion counter is less than the predetermined value so that the answer of step S6 is NO, the routine progresses to step S8 to maintain the status of the torsion flag in the previous routine, and thereafter returns. Here, step S7 corresponds to the "torsion determiner" of the exemplary embodiment of the present disclosure.

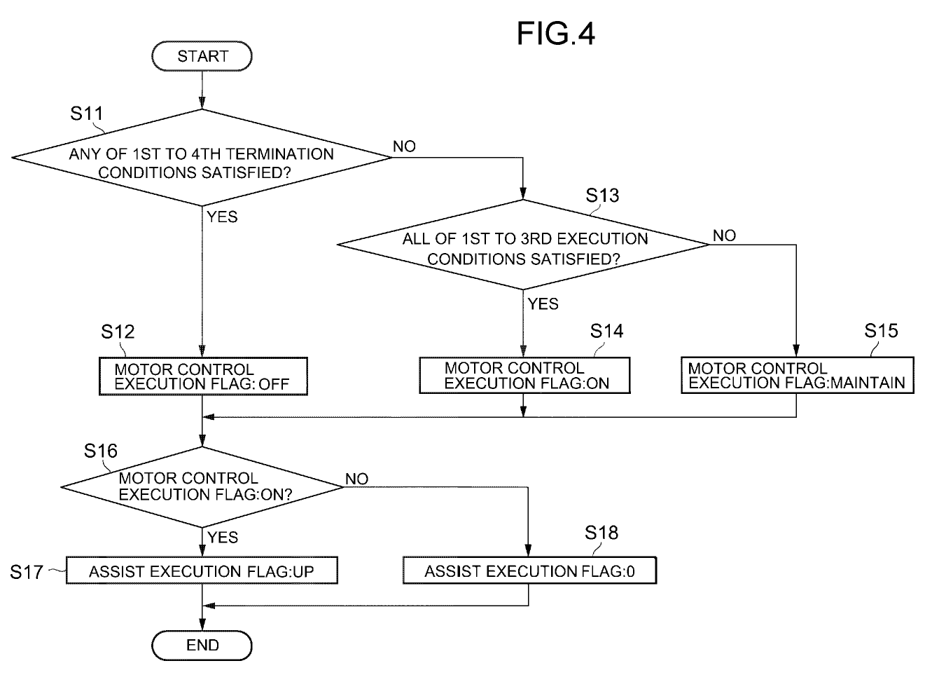

Next, one example of the routine for determining whether to generate the assist torque by the motor 1 when releasing the intermediate shaft 5 by the parking lock mechanism 11 will be explained with reference to FIG. 4. At step S11, it is determined whether or not the condition to terminate the generation of the assist torque by the motor 1 is satisfied. Specifically, it is determined whether at least any one of the following first to fourth termination conditions is/are satisfied. More specifically, it is determined whether the first termination condition that the motor 1 is generating the assist torque continuously for a predetermined period of time or longer is satisfied. In other words, it is determined whether the first termination condition that a count value of the after-mentioned assist execution counter is equal to or greater than a predetermined value is satisfied. In addition, it is determined whether the second termination condition that the drive shaft 9 is unlocked by the parking lock mechanism 11 is satisfied. In other words, it is determined whether the second termination condition that an operating mode other than the parking mode is selected is satisfied. Further, it is determined whether the third termination condition that the torsion of the drive shaft 9 has been eliminated is satisfied. Specifically, it is determined whether the third termination condition that an absolute value of a rotational speed (or rotational angle) of the motor 1 is equal to or greater than a predetermined speed (or predetermined angle) is satisfied. Furthermore, it is determined whether the fourth termination condition that some kind of failure has occurred while the motor 1 is generating the assist torque is satisfied. In short, it is determined whether the fourth termination condition that the abnormality flag is on is satisfied.

If at least any one of the above-mentioned first to fourth termination conditions is/are satisfied so that the answer of step S11 is YES, the routine progresses to step S12 to turn off a motor control execution flag for executing the control to generate the assist torque by the motor 1.

By contrast, if the count value of the assist execution counter is less than the predetermined value, the parking range is selected, the absolute value of the rotational speed of the motor 1 is less than the predetermined speed, and the abnormality flag is off, that is, if none of the first to fourth termination conditions is satisfied, the answer of step S11 will be NO. In this case, the routine progresses to step S13 to determine the satisfaction of all of the following first to third execution conditions are satisfied. Specifically, at step S13, it is determined whether the first execution condition that the shifting operation to select the operating mode other than the parking mode is executed is satisfied, whether the second execution condition that the torsion flag is on is satisfied, and whether the third execution condition that the inclination angle of the vehicle Ve in the pitching direction is equal to or greater than the second predetermined angle is satisfied. To this end, the second inclination angle determiner 34 determines whether the inclination angle of the vehicle Ve in the pitching direction is equal to or greater than the second predetermined angle, and the second predetermined angle may be set to the same angle as the first predetermined angle employed at step S6 of the routine shown in FIG. 3.

If the shifting operation to select the operating mode other than the parking mode is executed, the torsion flag is on, and the inclination angle of the vehicle Ve in the pitching direction is equal to or greater than the second predetermined angle, that is, if all of the first to third execution conditions are satisfied so that the answer of step S13 is YES, the routine progresses to step S14 to turn on the motor control execution flag. By contrast, if at least any one of the first to third execution conditions is/are not satisfied so that the answer of the step S13 is NO, the routine progresses to step S15 to maintain a status of the motor control execution flag in the previous routine.

Then, the routine further progresses to step S16 to determine whether the motor control execution flag is on. If the motor control execution flag is on so that the answer of step S16 is YES, the routine progresses to step S17 to increment the count value of the assist execution counter, and thereafter returns. By contrast, if the motor control execution flag is off so that the answer of step S16 is NO, the routine progresses to step S18 to reset the count value of the assist execution counter to zero, and thereafter returns.

Thus, the motor control execution flag is turned on in the situation where the inclination angle of the vehicle Ve at the point when the drive shaft 9 was locked by the parking lock mechanism 11 is equal to or greater than the first predetermined angle, the drive shaft 9 is twisted, and the inclination angle of the vehicle Ve at the point when the drive shaft 9 is released by the parking lock mechanism 11 is equal to or greater than the second predetermined angle. In other words, the assist torque is generated by the motor 1. Therefore, in the case that the posture of the vehicle Ve being parked is changed when e.g., the vehicle Ve is towed, the motor 1 is prevented from generating the assist torque. In other words, in the case that the vehicle Ve being parked is towed and then laid in a horizontal attitude so that the torsion of the drive shaft 9 is eliminated, generation of the assist torque by the motor 1 is inhibited. For this reason, the vehicle Ve will not be vibrated by the assist torque of the motor 1 when releasing the drive shaft 9 by the parking lock mechanism 11.

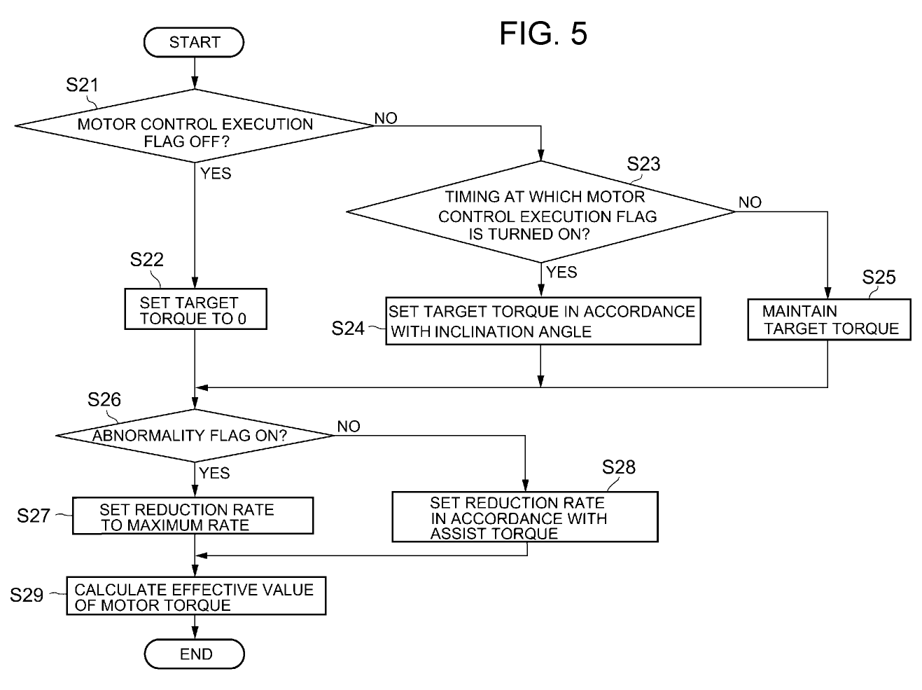

Turning to FIG. 5, there is shown one example of a routine executed by the ECU 21 to determine the assist torque to be generated by the motor 1. At step S21, it is determined whether the motor control execution flag is off. If the motor control execution flag is off so that the answer of step S21 is YES, the routine progresses to step S22 to set a target value of the assist torque to be generated by the motor 1 (hereinafter, simply referred to as the target torque) to zero. By contrast, if the motor control execution flag is on so that the answer of step S21 is NO, the routine progresses to step S23 to determine whether it is a timing at which the motor control execution flag being off is turned on. Such determination at step S23 may be made based on whether or not the answer of step S21 in the previous routine was YES.

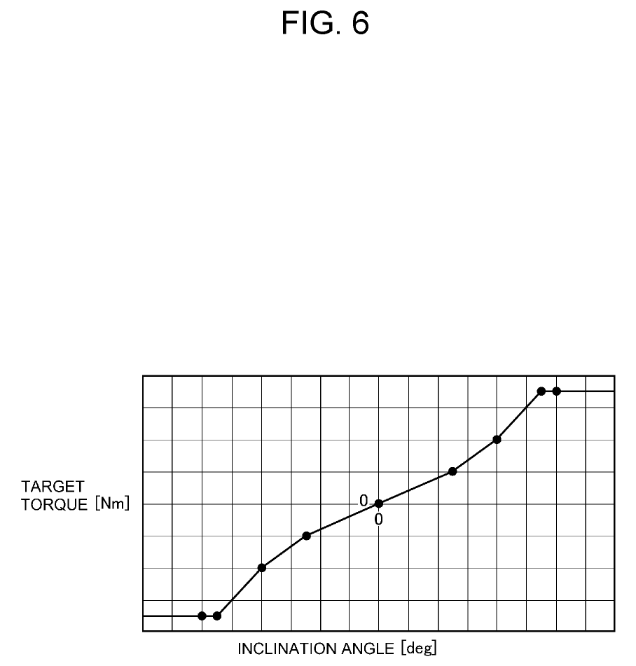

If it is the timing at which the motor control execution flag being off is turned on so that the answer of step S23 is YES, the routine progresses to step S24 to set the target torque based on the inclination angle of the vehicle Ve at this point. Specifically, the inclination angle of the vehicle Ve is calculated based on an acceleration of the vehicle Ve detected by the acceleration sensor 22, and the target torque is determined based on the calculated inclination angle with reference to a map shown in FIG. 6 prepared based on a result of an experiment conducted in advance. In FIG. 6, the horizontal axis represents the inclination angle of the vehicle Ve, and the vertical axis represents the target torque. As can be seen from FIG. 6, the target torque is increased with an increase in the inclination angle of the vehicle Ve.

By contrast, if it is not the timing at which the motor control execution flag being off is turned on, that is, if the target value of the assist torque to be generated by the motor 1 has already been set in the previous routine so that the answer of step S23 is NO, the routine progresses to step S25 to maintain the target value of the assist torque of the motor 1 to the previous value.

Then, a reduction rate of the assist torque generated by the motor 1 is determined. To this end, it is determined at step S26 whether some kind of failure e.g., a communication error that the ECU 21 cannot receive a signal representing the braking torque established by the brake device 14 or the EPB 15 has occurred while the motor 1 is generating the assist torque. At step S6, specifically, it is determined whether or not the abnormality flag is on.

If the abnormality flag is on so that the answer of step S26 is YES, the routine progresses to step S27 to set the reduction rate of the assist torque of the motor 1 to the maximal rate determined based on the specification of the motor 1 in advance. By contrast, if the abnormality flag is off so that the answer of step S26 is NO, the routine progresses to step S28 to set the reduction rate of the assist torque of the motor 1 to a rate determined in accordance with a magnitude of the assist torque of the motor 1 (i.e., the target torque) such that the assist torque is reduced within a predetermined period of time.

Then, at step S29, an effective value of the output torque of the motor 1 is calculated by multiplying the target value of the assist torque of the motor 1 by the reduction rate set at step S27 or S28 and an elapsed time, and thereafter the routine returns.

Thus, the target value of the assist torque to be generated by the motor 1 is determined based on the inclination angle of the vehicle Ve at the point when the motor control executing flag being off is turned on. Therefore, the target value of the assist torque will not be changed even if the detected value of the acceleration sensor 22 is fluctuated by the vibrations of the vehicle Ve while the assist torque is generated by the motor 1, or even if the signal transmitted from the acceleration sensor 22 to the ECU 21 contains a noise. For this reason, the assist torque of the motor 1 will not be changed by the factors other than the torsion of the drive shaft 9 so that the vehicle Ve may be prevented from being vibrated.

According to the foregoing examples, the motor control executing flag is turned on in the case that the inclination angle of the vehicle Ve at the point when the drive shaft 9 is locked by the parking lock mechanism 11 is equal to or greater than the first inclination angle, and that the inclination angle of the vehicle Ve at the point when the drive shaft 9 is released by the parking lock mechanism 11 is equal to or greater than the second inclination angle. However, the torsion angle of the drive shaft 9 is governed by the inclination angle of the vehicle Ve. Therefore, even if the inclination angle of the vehicle Ve at the point when the intermediate shaft 5 is released by the parking lock mechanism 11 is equal to or greater than the second inclination angle, the inclination angle of the vehicle Ve may have been increased excessively from that at the point when the drive shaft 9 was locked by the parking lock mechanism 11. In this case, if the motor 1 generates the assist torque determined based on the inclination angle of the vehicle Ve at the point when the drive shaft 9 was locked by the parking lock mechanism 11, the assist torque generated by the motor 1 may be excessive or insufficient to reduce the vibrations of vehicle Ve.

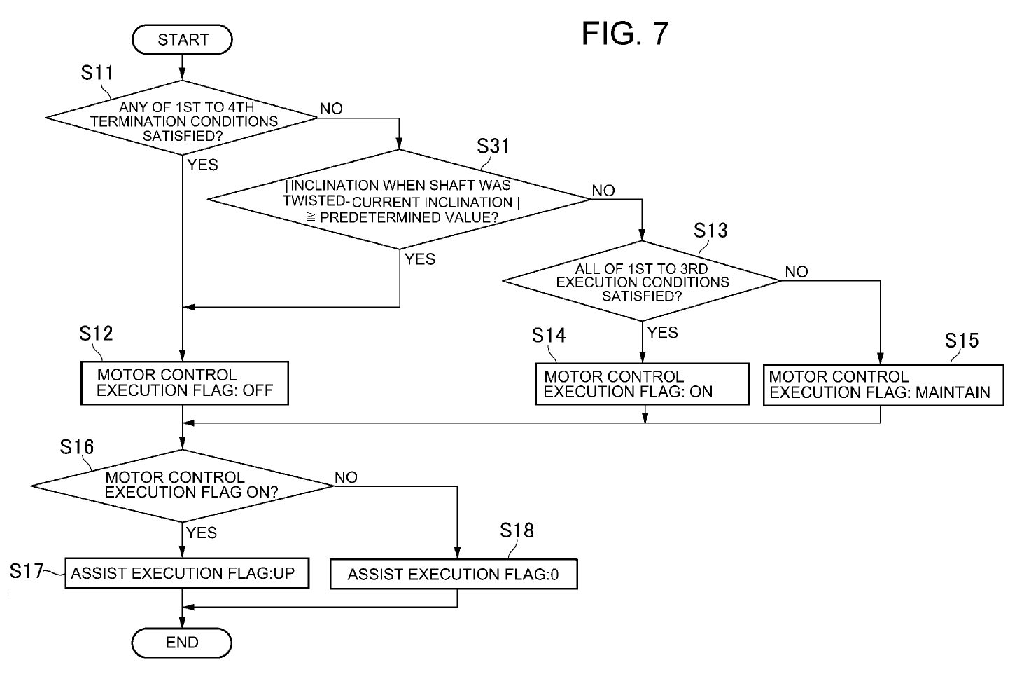

Therefore, the control system according to the exemplary embodiment of the present disclosure is further configured to turn off the motor control executing flag in the case that the difference between the inclination angle of the vehicle Ve at the point when the drive shaft 9 was locked by the parking lock mechanism 11 and the inclination angle of the vehicle Ve at the point when the drive shaft 9 is released by the parking lock mechanism 11 is large. To this end, specifically, the control system executes the routine shown in FIG. 7. In the following descriptions, detailed explanations for the steps in common with those in FIG. 4 will be omitted.

According to the routine shown in FIG. 7, if none of the above-mentioned first to fourth termination conditions is satisfied so that the answer of step S11 is NO, the routine progresses to step S31 to determine whether an absolute value of the difference between the inclination angle of the vehicle Ve at the point when the drive shaft 9 was locked by the parking lock mechanism 11 (i.e., the inclination angle at the point when the torsion of the drive shaft 9 was twisted) and the inclination angle of the vehicle Ve at the point when the drive shaft 9 is released by the parking lock mechanism 11 (i.e., the current inclination angle) is equal to or greater than a predetermined value. To this end, the predetermined value employed at step S31 may be set to e.g., a value corresponding to a detection error of the acceleration sensor 22, or a value by which a change in a posture of the vehicle Ve can be determined.

If the difference between the inclination angle of the vehicle Ve at the point when the drive shaft 9 was twisted and the current inclination angle is equal to or greater than the predetermined value so that the answer of the step S31 is YES, the torsion angle of the drive shaft 9 may not be determined accurately. In this case, therefore, the routine progresses to step S12 to turn off the motor control execution flag. Consequently, the generation of the assist torque by the motor 1 is inhibited.

By contrast, If the difference between the inclination angle of the vehicle Ve at the point when the drive shaft 9 was twisted and the current inclination angle is less than the predetermined value so that the answer of the step S31 is NO, it is considered that the posture of the vehicle Ve is not changed. In this case, therefore, the routine progresses to step S13 to determine whether to turn on the motor control execution flag or to maintain the motor control execution flag to be on.

Thus, the control system according to the exemplary embodiment of the present disclosure is further configured to determine the change in the posture of the vehicle Ve by determining whether to generate the assist torque by the motor 1 based on the difference between the inclination angle of the vehicle Ve at the point when the drive shaft 9 was locked by the parking lock mechanism 11 and the inclination angle of the vehicle Ve at the point when the drive shaft 9 is released by the parking lock mechanism 11. In other words, it is possible to determine whether the torsion angle of the drive shaft 9 has changed by the foregoing procedures. Therefore, the vehicle Ve will not be vibrated by the assist torque of the motor 1 by inhibiting the generation of the assist torque by the motor 1 in the situation where the posture of the vehicle Ve has changed significantly.

In addition, if the inclination direction of the vehicle Ve in the pitching direction at the point when releasing the drive shaft 9 by the parking lock mechanism 11 has changed from that at the point when the drive shaft 9 was locked by the parking lock mechanism 11, a torsional direction of the drive shaft 9 may have been reversed. In order to reduce the vibrations of the vehicle Ve, the assist torque of the motor 1 is generated in a direction to counteract the torsional torque of the drive shaft 9. Therefore, if the torsional direction of the drive shaft 9 is reversed, it is necessary to generate the assist torque by the motor 1 in the opposite direction. In the situation where the posture of the vehicle Ve has changed as explained above, the vibration of the vehicle Ve may be amplified if the motor 1 generates the assist torque in the direction according to the inclination direction of the vehicle Ve at the point when the drive shaft 9 was locked by the parking lock mechanism 11.

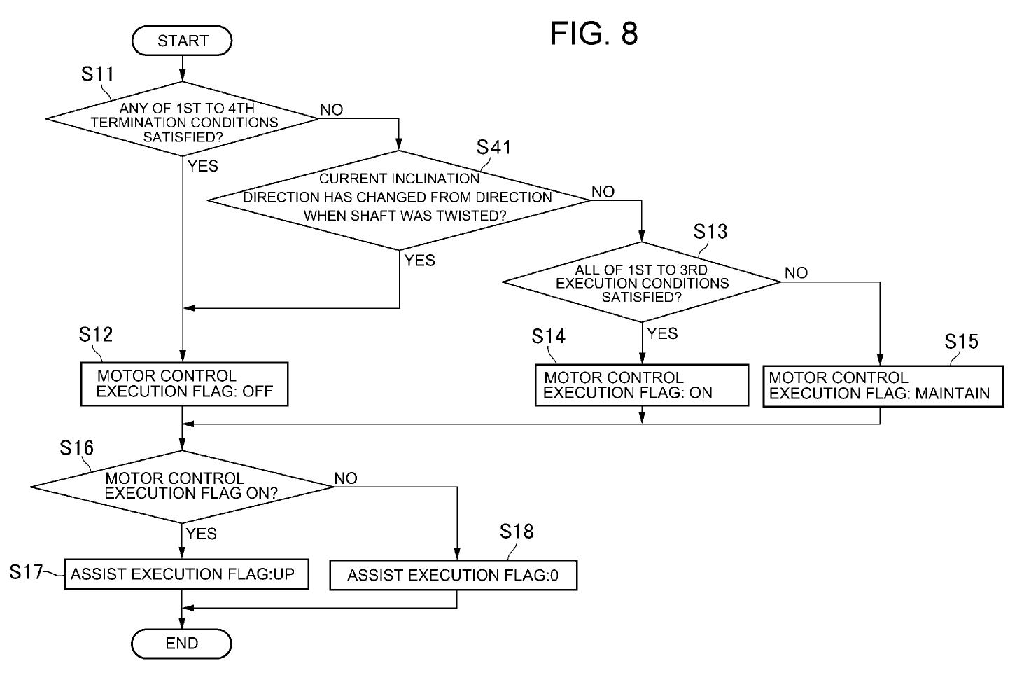

In order to avoid such disadvantage, the control system according to the exemplary embodiment of the present disclosure is further configured to turn off the motor control executing flag in the case that the inclination direction of the vehicle Ve in the pitching direction at the point when releasing the drive shaft 9 by the parking lock mechanism 11 has changed from that at the point when the drive shaft 9 was locked by the parking lock mechanism 11. To this end, specifically, the control system executes the routine shown in FIG. 8. In the following descriptions, detailed explanations for the steps in common with those in FIG. 4 will be omitted.

According to the routine shown in FIG. 8, if none of the above-mentioned first to fourth termination conditions is satisfied so that the answer of step S11 is NO, the routine progresses to step S41 to determine whether the inclination direction of the vehicle Ve at the point when releasing the drive shaft 9 by the parking lock mechanism 11 (i.e., the current inclination direction) has changed from the inclination direction of the vehicle Ve at the point when the drive shaft 9 was locked by the parking lock mechanism 11 (i.e., the inclination angle at the point when the drive shaft 9 was twisted). For example, such determination at stepS41 may be made based on whether the detection signal transmitted from the acceleration sensor 22 is a positive value or a negative value.

For example, the answer of step S41 will be YES in a case that the vehicle Ve was inclined such that the front section thereof was oriented upward in the vertical direction when the drive shaft 9 was locked by the parking lock mechanism 11, and that the vehicle Ve is inclined such that the front section thereof is oriented downward in the vertical direction when the drive shaft 9 is released by the parking lock mechanism 11. Likewise, the answer of step S41 will also be YES in a case that the vehicle Ve was inclined such that the front section thereof was oriented downward in the vertical direction when the drive shaft 9 was locked by the parking lock mechanism 11, and that the vehicle Ve is inclined such that the front section thereof is oriented upward in the vertical direction when the drive shaft 9 is released by the parking lock mechanism 11. If the current inclination direction has changed from the inclination direction of the vehicle Ve at the point when the drive shaft 9 was twisted so that the answer of the step S41 is YES, the torsion angle of the drive shaft 9 may not be determined accurately or the torsional direction of the drive shaft 9 may be reversed. In this case, therefore, the routine progresses to step S12 to turn off the motor control execution flag. Consequently, the generation of the assist torque by the motor 1 is inhibited.

By contrast, if the current inclination direction has not changed from the inclination direction of the vehicle Ve at the point when the drive shaft 9 was twisted so that the answer of the step S41 is NO, it is considered that the posture of the vehicle Ve is not changed. In this case, therefore, the routine progresses to step S13 to determine whether to turn on the motor control execution flag or to maintain the motor control execution flag to be on.

Thus, the control system according to the exemplary embodiment of the present disclosure is further configured to determine the change in the torsional direction of the drive shaft 9 by determining whether to generate the assist torque by the motor 1 based on the inclination direction of the vehicle Ve at the point when the drive shaft 9 was locked by the parking lock mechanism 11 and the inclination direction of the vehicle Ve at the point when the drive shaft 9 is released by the parking lock mechanism 11. Therefore, the vehicle Ve will not be vibrated by the assist torque of the motor 1 by inhibiting the generation of the assist torque by the motor 1 in the situation where the torsional direction of the drive shaft 9 has changed.

Although the above examples of the present disclosure have been described, it will be understood by those skilled in the art that the present disclosure should not be limited to the described examples, and various changes and modifications can be made within the scope of the present disclosure. For example, the control system according to the exemplary embodiment of the present disclosure may also be applied to an electric vehicle in which torque is distributed from one motor to a pair of front wheels or rear wheels or to all wheels. In addition, the control system according to the exemplary embodiment of the present disclosure may also be applied to a hybrid-vehicle in which a prime mover includes a motor and an engine.

Further, a configuration to join the drive shaft 9 to the motor 1, and the rotary member whose rotation is stopped by the parking lock mechanism 11 are not limited to those shown in FIG. 1. Furthermore, the EPB 15 may be omitted from the vehicle Ve. In this case, torsion flag is turned on and off based on whether or not the braking torque is applied to the wheel 10 by the brake device 14.

What is claimed is:

1. A control system for a vehicle, comprising:
a drive shaft in which one end thereof is joined to a wheel;
a motor that applies a torque to the drive shaft; and
a parking lock mechanism that stops a rotation of a predetermined rotary member arranged between the motor and the drive shaft by locking the rotary member, and that allows the rotary member to rotate by releasing the rotary member;
the control system comprising:
a controller that controls the motor,
wherein the controller comprises:
a first inclination angle determiner configured to determine whether an inclination angle of the vehicle in the pitching direction at a point when the rotary member is locked by the parking lock mechanism is equal to or greater than a first predetermined angle;
a torsion determiner configured to determine whether the drive shaft is twisted after locking the rotary member by the parking lock mechanism;
a second inclination angle determiner configured to determine whether the inclination angle of the vehicle in the pitching direction at a point when the rotary member is released by the parking lock mechanism is equal to or greater than a second predetermined angle; and
a motor controller configured to control the motor to generate an assist torque in a direction to counteract the torsional torque acting on the drive shaft, in a situation where:
the inclination angle of the vehicle in the pitching direction at the point when the rotary member was locked by the parking lock mechanism is equal to or greater than the first predetermined angle;
torsion of the drive shaft is determined; and
the inclination angle of the vehicle in the pitching direction at the point when the rotary member is released by the parking lock mechanism is equal to or greater than the second predetermined angle.

2. The control system for the vehicle as claimed in claim 1, wherein the motor controller is further configured to determine a magnitude of the assist torque to be generated by the motor in accordance with the inclination angle of the vehicle in the pitching direction at the point when releasing the rotary member by the parking lock mechanism.

3. The control system for the vehicle as claimed in claim 1, wherein the controller further comprises:
a motor control inhibitor configured to inhibit the motor to generate the assist torque in a case that a difference between the inclination angle of the vehicle in the pitching direction at the point when the rotary member was locked by the parking lock mechanism and the inclination angle of the vehicle in the pitching direction at the point when the rotary member is released by the parking lock mechanism is equal to or greater than a predetermined value.

4. The control system for the vehicle as claimed in claim 2, wherein the controller further comprises:
a motor control inhibitor configured to inhibit the motor to generate the assist torque in a case that a difference between the inclination angle of the vehicle in the pitching direction at the point when the rotary member was locked by the parking lock mechanism and the inclination angle of the vehicle in the pitching direction at the point when the rotary member is released by the parking lock mechanism is equal to or greater than a predetermined value.

5. The control system for the vehicle as claimed in claim 1, wherein the controller further comprises:
a motor control inhibitor configured to inhibit the motor to generate the assist torque in a case that the inclination direction of the vehicle in the pitching direction at the point when releasing the rotary member by the parking lock mechanism has changed from that at the point when the rotary member was locked by the parking lock mechanism.

6. The control system for the vehicle as claimed in claim 2, wherein the controller further comprises:
a motor control inhibitor configured to inhibit the motor to generate the assist torque in a case that the inclination direction of the vehicle in the pitching direction at the point when releasing the rotary member by the parking lock mechanism has changed from that at the point when the rotary member was locked by the parking lock mechanism.
